(19) United States
(12) Patent Application Publication
(10) Pub. No.: US 2020/0256092 A1
(43) Pub. Date: Aug. 13, 2020

(54) Theft Deterrent Anchor

(71) Applicant: Austin Robert Boll, Jacksonville, FL (US)

(72) Inventor: Austin Robert Boll, Jacksonville, FL (US)

(21) Appl. No.: 16/271,816

(22) Filed: Feb. 9, 2019

(51) Int. Cl. E05B 73/00; E05B 67/38

(52) U.S. Cl. CPC E05B 73/0005; E05B 67/383

(57) ABSTRACT

A Theft Deterrent Anchor (1) is affixed immovably to a surface position proximate a concrete or asphalt (10) parking place and has a hardened chain (3) that is lockable through a motorcycle wheel to prevent the motorcycles theft by being carried or towed away. The hardened chain (3) is attached to the Theft Deterrent Anchor (1) by a padlock (2) and can only be removed from the locking position through the wheel. The Theft Deterrent Anchor is anchored in two places to the concrete or asphalt (10) below preventing anything or anyone to pick up or move it. Thus, security of the two-wheeled or three-wheeled vehicle (4) is provided by the device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### STATEMENT REGARDING PRIOR DISCLOSURES BY THE INVENTOR OR A JOINT INVENTOR

Not Applicable

### BACKGROUND OF THE INVENTION

Other anti-theft systems for transport vehicles consist of disc locks, trackers and locked chains around the vehicle. This invention relates to the prevention of theft to two-wheel or three-wheel transport vehicles, and particularly to anchoring a wheel to concrete or asphalt to prevent theft from public and private parking places. Presently there is no solution to lock a vehicle to the ground surface to make removal of the vehicle difficult.

### FIELD OF THE INVENTION

The present invention relates to an anti-theft device used for two-wheeled or three-wheeled vehicles on a concrete or asphalt base.

### DESCRIPTION OF RELATED ART

Not Applicable

### BRIEF SUMMARY OF THE INVENTION

The Theft Deterrent Anchor is a forged piece of metal with a rust-resistant coating applied, accompanied by two anchor bolts, and two tamperproof nuts. These along with a hardened chain and padlock create the Theft Deterrent Anchor designed to be permanently anchored to an asphalt or concrete base which secures any two-wheel or three-wheel vehicle.

### BRIEF DESCRIPTION OF THE SEVERAL VIEWS OF THE DRAWING(S)

FIG. 1 is a partially cutaway top view of the Theft Deterrent Anchor in a assembled stage and non-ready to use mode.

FIG. 2 is a partially cutaway bottom view of the Theft Deterrent Anchor in a assembled stage and non-ready to use mode.

FIG. 3 is a partially cutaway front view of the Theft Deterrent Anchor in a assembled stage and non-ready to use mode.

FIG. 4 is a partially cutaway back view of the Theft Deterrent Anchor in a assembled stage and non-ready to use mode.

FIG. 5 is a partially cutaway left view of the Theft Deterrent Anchor in a assembled stage and non-ready to use mode.

FIG. 6 is a partially cutaway right view of the Theft Deterrent Anchor in a assembled stage and non-ready to use mode.

FIG. 7 is a partially cutaway isometric view of the Theft Deterrent Anchor in a assembled stage and non-ready to use mode.

FIG. 8 is a partially cutaway perspective view of the Theft Deterrent Anchor in a assembled stage and non-ready to use mode.

FIG. 9 is a partially cutaway front view of the Theft Deterrent Anchor in position and order of assembly and preparation to use mode with concrete or asphalt base.

FIG. 10 is a partially cutaway perspective view of the Theft Deterrent Anchor in a assembled stage and ready to use mode with hardened chain and padlock.

FIG. 11 is a partially cutaway left x-ray view of the Theft Deterrent Anchor in a assembled stage and ready to use mode with hardened chain and padlock anchored to a concrete or asphalt base.

FIG. 12 is a partially cutaway perspective view of the Theft Deterrent Anchor in a assembled stage and ready to use mode with hardened chain and padlock anchored to a concrete or asphalt base accompanied by a two wheel vehicle.

FIG. 13 is a partially cutaway top view of the Theft Deterrent Anchor in a assembled stage and ready to use mode with hardened chain and padlock anchored to a concrete or asphalt base accompanied by a two wheel vehicle.

### DETAILED DESCRIPTION OF THE INVENTION

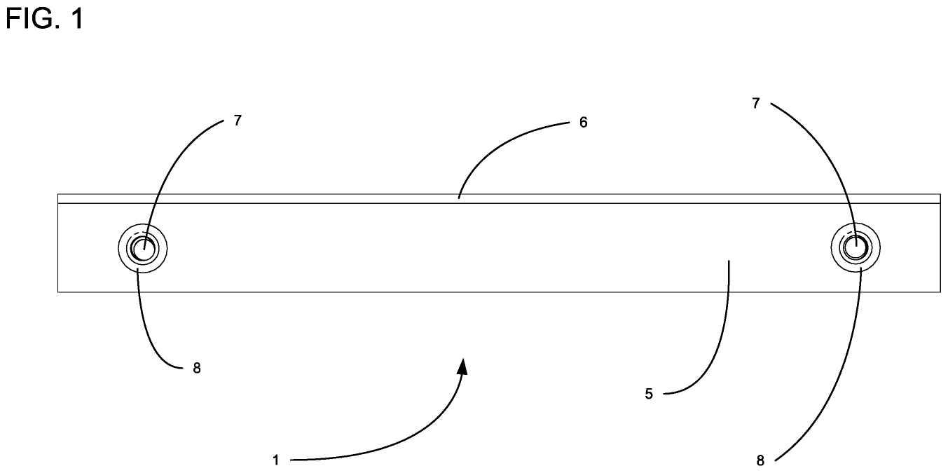

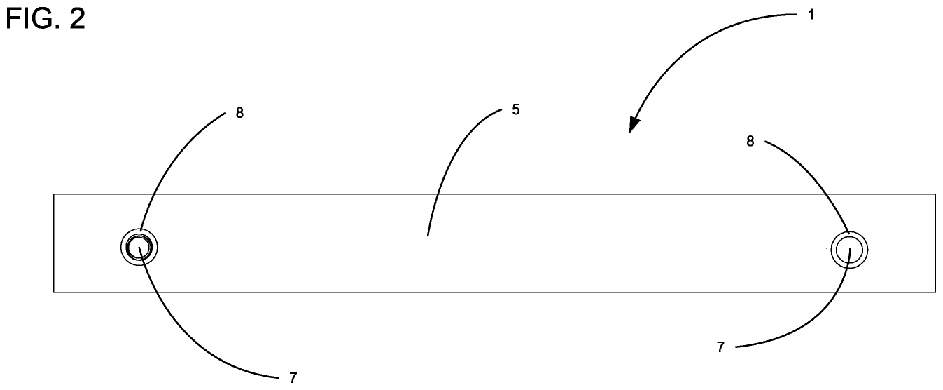

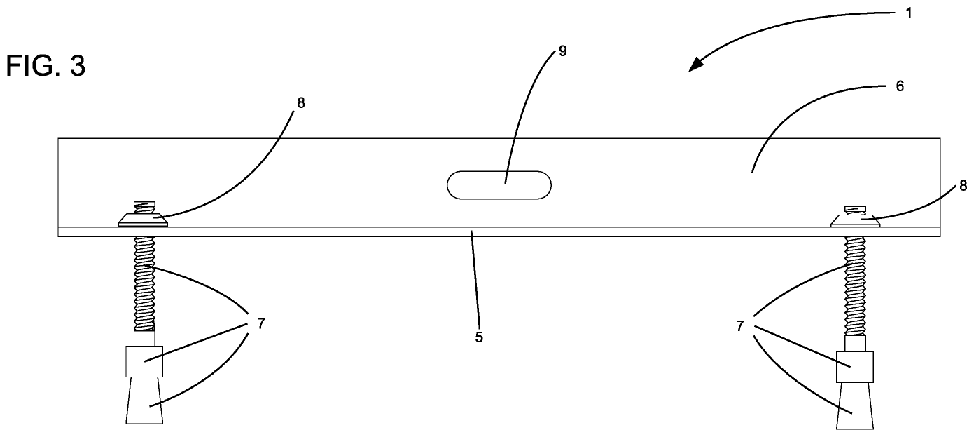

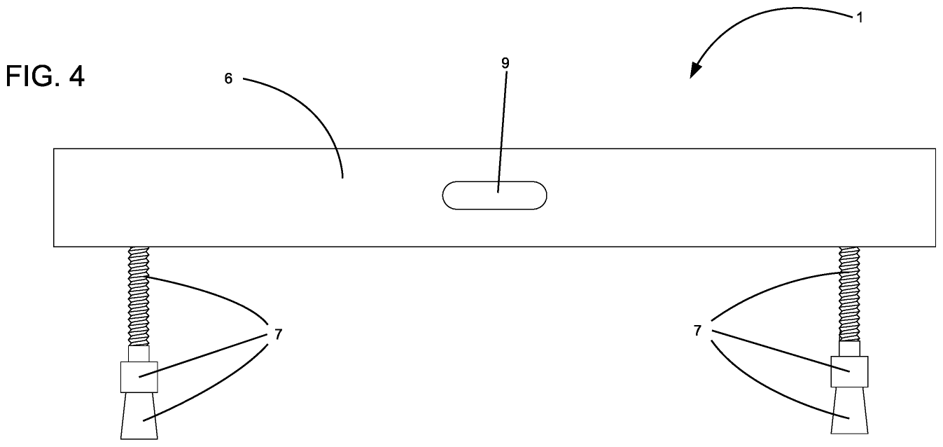

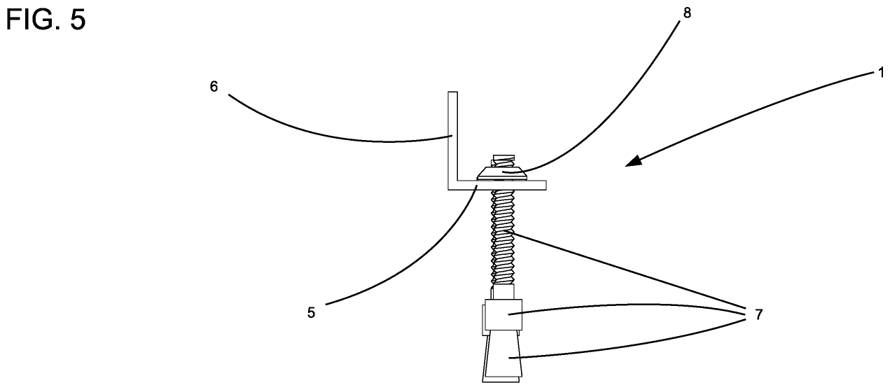

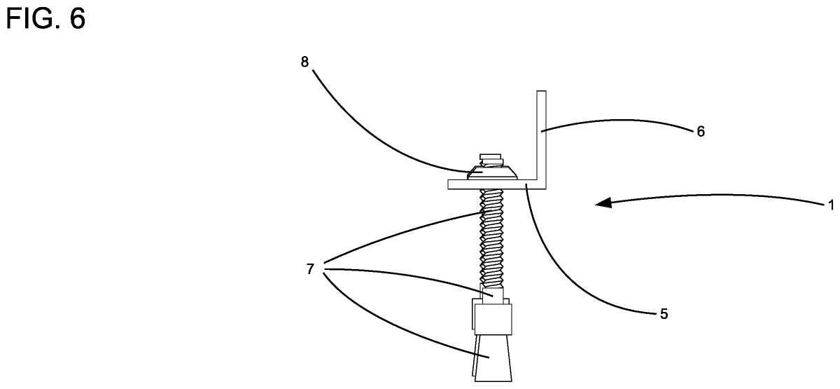

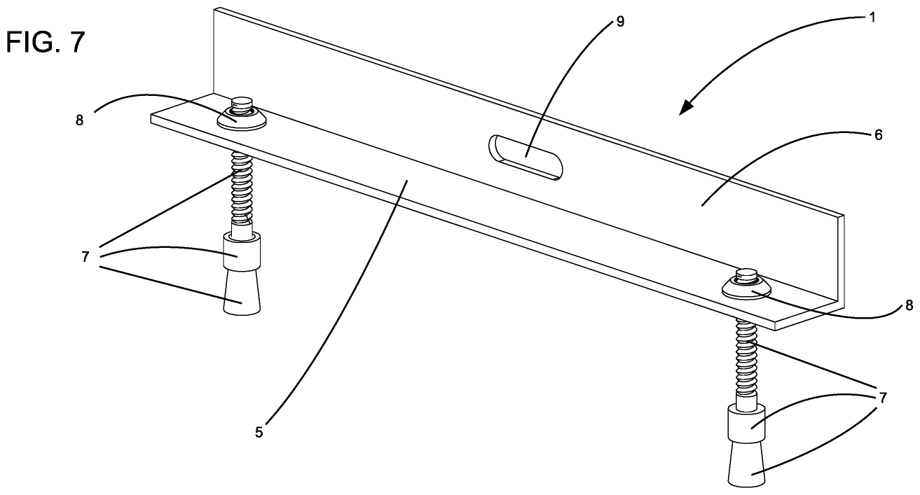

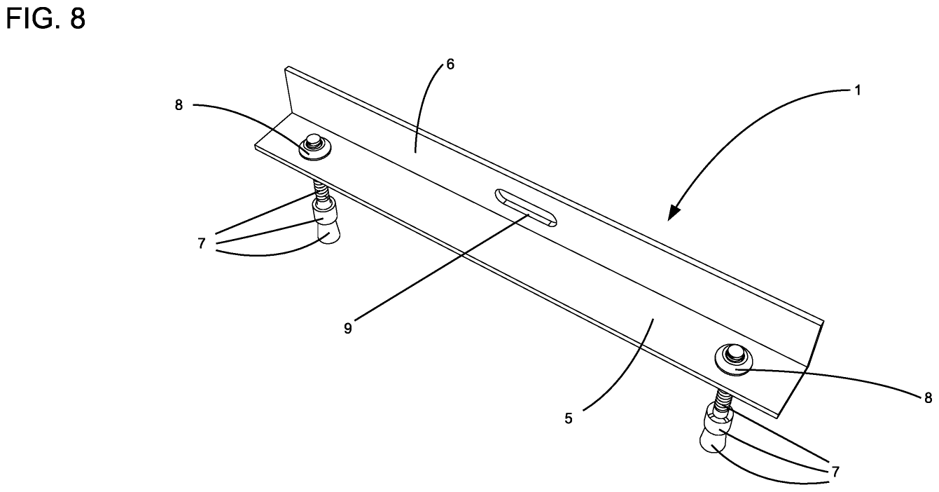

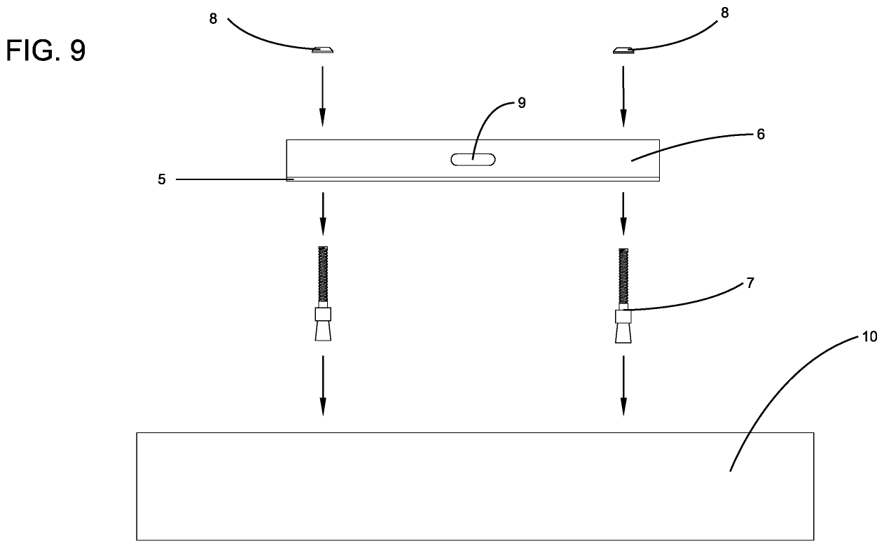

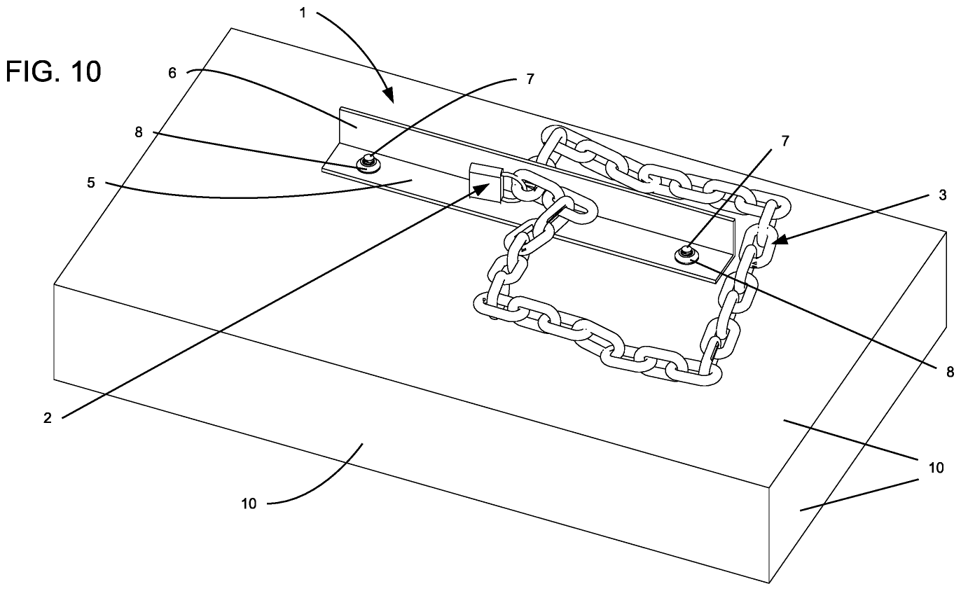

Reference is made first to FIGS. 1-8 of the drawings. The Theft Deterrent Anchor 1 is made up of a horizontal piece of hardened steel 5 and a vertical piece of hardened steel 6. There are two drilled holes in the horizontal piece of hardened steel 5 for the anchor bolts 7 to slide through from the bottom upwards. The tamper proof nuts 8 are then applied to the top of the anchor bolts 7 to hold down the Theft Deterrent Anchor 1 to a asphalt or concrete base 10 seen in FIGS. 9-13. The milled out section 9 on the vertical piece of hardened steel 6 is for the hardened chain 3 seen in FIGS. 10-13 to slide through the piece of hardened steel 6 and be locked by a padlock 2 seen in FIGS. 10-13.

In reference to FIG. 9 the anchor bolts 7 are drilled into a concrete or asphalt base 10. The horizontal piece of hardened steel 5 and the vertical piece of hardened steel 6 are placed on top and aligned with the anchor bolts 7 in the concrete or asphalt base 10 and tightened by the tamper proof nuts 8.

FIG. 10 shows the Theft Deterrent Anchor 1 fully locked down to concrete or asphalt 10 with the hardened chain 3 and the padlock 2 in ready to use mode.

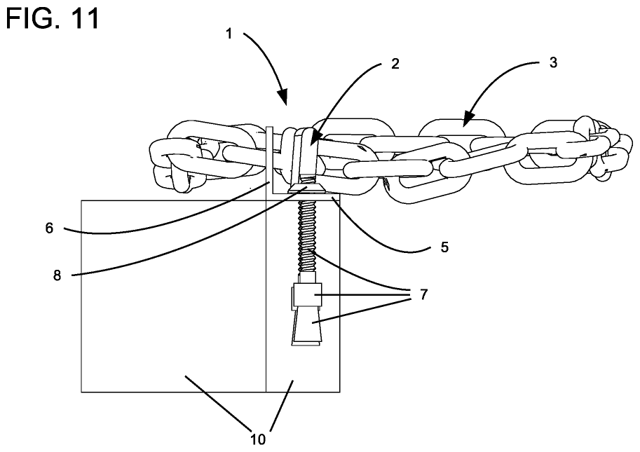

FIG. 11 shows the Theft Deterrent Anchor 1 fully locked down to concrete or asphalt 10 in a x-ray view with the hardened chain 3 and the padlock 2 in ready to use mode.

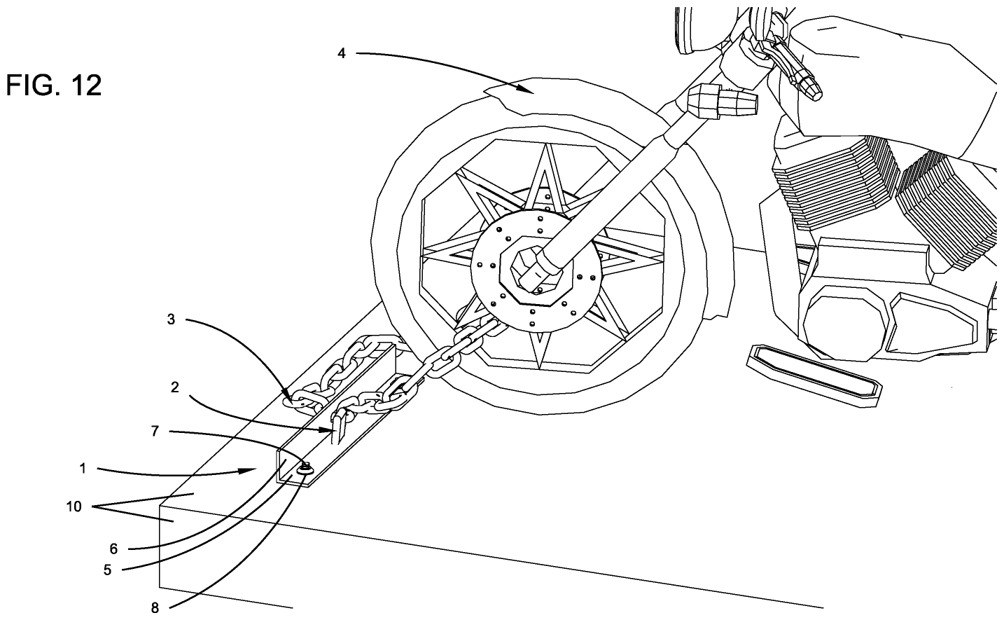

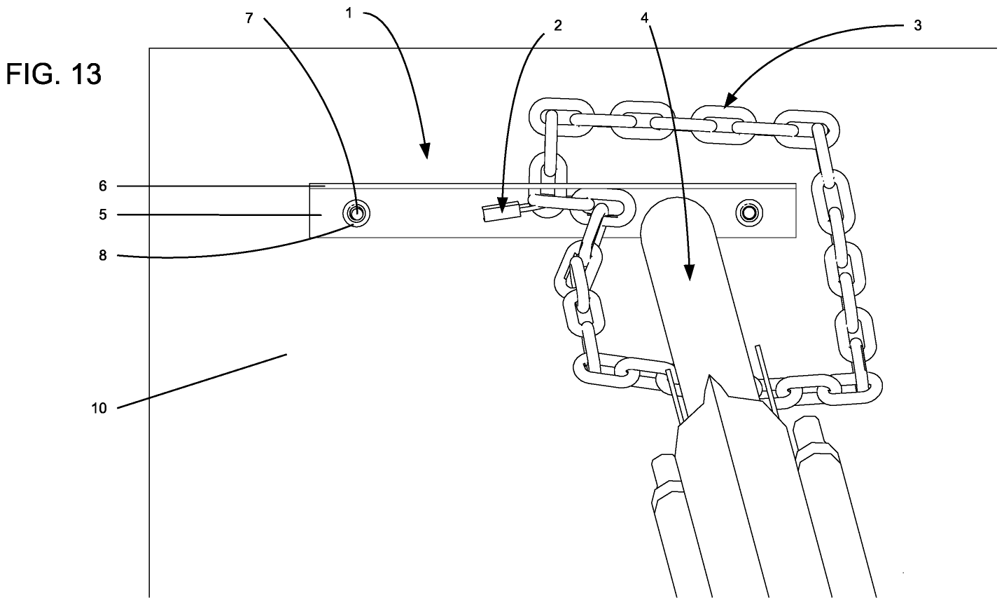

In FIGS. 12-13 the Theft Deterrent Anchor 1 is accompanied by the hardened chain 3 and the padlock 2 to lock down the two or three wheel vehicle 4. The hardened chain 3 is used to go through the wheel of any two or three wheel vehicle 4 attached to the Theft Deterrent Anchor 1 and locked by the padlock 2 to the ground surface for difficult removal.

What is claimed is:

1. A Theft Deterrent Anchor assembly, comprising a angular section of hardened steel, anchor bolts, tamperproof nuts, a hardened steel chain, a padlock, and a key; the angular section of hardened steel having a section cut for the chain to insert, sections cut for the entry of anchor bolts.

2. The Theft Deterrent Anchor assembly as claimed in claim 1, wherein the installation surface is an asphalt or concrete base for difficult removal.

3. The Theft Deterrent Anchor assembly as claimed in claim 1, wherein the section of hardened steel is coated with a rust-resistant coating for outdoor use.

4. The Theft Deterrent Anchor assembly as claimed in claim 1, wherein the tamper proof nuts have a key for disassembly from the concrete or asphalt base.

5. The Theft Deterrent Anchor assembly as claimed in claim 1, wherein the chain has a nylon sleeve for protection against scratches to the wheel of the transportation vehicle.
